(19) United States
(12) Patent Application Publication
(10) Pub. No.: US 2026/0012560 A1
(43) Pub. Date: Jan. 8, 2026

(54) Copresence System

(71) Applicant: Google LLC, Mountain View, CA (US)

(72) Inventors: Donald A. Barnett, Monroe, WA (US); Corbin Alexander Cunningham, Seattle, WA (US); Benjamin Guy Alexander Pawle, London (GB); Phoebe Kirkland, London (GB); George Joseph Rickerby, London (GB); Michael Colville, London (GB)

(21) Appl. No.: 18/992,158

(22) PCT Filed: Jul. 20, 2022
(86) PCT No.: PCT/US2022/037693

§ 371 Date: Jan. 7, 2025

(51) Int. Cl. H04N 9/31; H04L 12/18; H04L 65/1089

(52) U.S. Cl. CPC H04N 9/3185; H04L 12/1831; H04L 65/1089; H04N 9/3182

(57) ABSTRACT

Techniques for improving collaboration in a video conferencing system are described herein. The system can include a projector configured to output a first user input. Additionally, the system can include a projector mirror configured to reflect the first user input outputted by the projector to a physical medium. The physical medium can include a drawing surface and be configured to display the first user input. Moreover, the system can include a first computing device having one or more that cause the first computing system to perform operations. The operations can include receiving, using an optical device, a second user input on the drawing surface. Furthermore, the operations can include generating the collaborative information by integrating the first user input and the second user input. Subsequently, the operations can include causing the projector to output the collaborative information.

### FIELD

The present disclosure relates generally to copresence technology. More particularly, the present disclosure relates to a portable copresence system that enables a plurality of participants at different locations to collaborate in real-time.

### BACKGROUND

Real-time interactive communication can take on many forms. Videoconferencing or other applications can help supply contextual information about the participants, which can promote robust and informative communication. However, it can be challenging to have remote collaboration where different participants are working on the same content at the same time. Connectivity issues and other bandwidth concerns, background distractions, and information overload from multiple video feeds can also create issues and hinder collaboration.

### BRIEF SUMMARY

Aspects and advantages of techniques described in the present disclosure will be set forth in part in the following description, or can be learned from the description, or can be learned through practice of the techniques.

One example aspect of the present disclosure is directed to a system for improving video conferencing collaboration. The system can include a projector configured to output a first user input of a first user. Additionally, the system can include a projector mirror configured to reflect the first user input outputted by the projector to a physical medium. The physical medium can include a drawing surface and be configured to display the first user input. Moreover, the system can include a first computing device having one or more processors. The one or more processors can cause the first computing system to perform operations. The operations can include receiving, using an optical device of the first computing device, a second user input on the drawing surface, the second user input being from a second user. Furthermore, the operations can include generating, using a copresence program, collaborative information by integrating the first user input and the second user input. Subsequently, the operations can include causing the projector to output the collaborative information.

In some implementations, the system can further include an input mirror configured to reflect the second user input from the physical medium to the optical device of the first computing device.

In some implementations, the operations can further include receiving, using the optical device of the first computing device, a raw image associated with an input tool of the second user. Additionally, the operations can include generating a silhouette representation corresponding to the input tool of the second user, the silhouette representation reprojecting aspects of the input tool according to a proximity of the input tool to the physical medium. By way of example, the input tool may be a finger of the user, or may be a stylus or other implement.

In some implementations, a first section of the silhouette representation is generated to have a first amount of blurring, and the first amount of blurring is based on the proximity of the input tool to the physical medium. In some implementations, there is a natural amount of blurring in distance until the user disappears for privacy or other purposes. For example, a second section of the silhouette representation is generated having a second amount of blurring, where the second section is a farther distance to the physical medium in comparison to the first section. In this example, the second amount of blurring is greater than the first amount of blurring.

In some implementations, a second silhouette representation is omitted from the image displayed on the physical medium when the second silhouette representation is greater than a threshold distance from the physical medium. For example, a participant can move a threshold distance from the physical medium so that their silhouette does not appear on the physical medium.

In some implementations, the silhouette representation is configured to illustrate a action of input tool of the second user, the action being either a point action or a follow action.

In some implementations, the collaborative information is displayed at a first resolution while the silhouette representation is displayed at a second resolution lower than the first resolution.

In some implementations, the silhouette representation is generated based on a set of skeleton coordinates derived from the raw image.

In some implementations, the system can further include a container. The container may have been created using a three-dimensional printer. In some instances, the projector can be attached to a first side of the container, the projector mirror and the input mirror can be attached to a second side of the container, and the physical medium and the first computing device can be attached to a third side of the container.

In some implementations, the physical medium comprises glass and vellum.

In some implementations, the operations can further include generating a bookmark associated with a time stamp, the bookmark including the collaborative information at the time stamp.

In some implementations, the operations can further include improving, using an homography technique, an image quality associated with the collaboration information, the homography technique having a calibration image with a plurality of control points being outputted by the projector to determine an amount of perspective warp.

Another example aspect of the present disclosure is directed to a computer-implemented method for improving collaboration in a video conferencing system. The method can include outputting, using a projector, a first user input of a first user. Additionally, the method can include reflecting, using a projector mirror, the first user input outputted by the projector to a physical medium. Moreover, the method can include displaying the first user input on a physical medium. The physical medium can have a drawing surface. Furthermore, the method can include receiving, using an optical device of a first computing device, a second user input on the drawing surface, the second user input being from a second user. The method can also include generating the collaborative information by integrating the first user input and the second user input. Subsequently, the method can include causing the projector to output the collaborative information.

Another example aspect of the present disclosure is directed to a computing system having one or more processors. The computing system includes one or more non-transitory, computer-readable media that store instructions that when executed by the one or more processors cause the computing system to perform operations. The operations can include outputting, using a projector, a first user input of a first user. Additionally, the operations can include reflecting, using a projector mirror, the first user input outputted by the projector to a physical medium. Moreover, the operations can include displaying the first user input on a physical medium. The physical medium can have a drawing surface. Furthermore, the operations can include receiving, using an optical device of a first computing device, a second user input on the drawing surface, the second user input being from a second user. The operations can also include generating the collaborative information by integrating the first user input and the second user input. Subsequently, the operations can include causing the projector to output the collaborative information.

### BRIEF DESCRIPTION OF THE DRAWINGS

FIGS. 1A-C depicts copresence scenarios according to an example of the present disclosure.

FIG. 2 depicts a copresence system according to an example of the present disclosure.

FIG. 3 depicts a side view showing a copresence system according to examples of the present disclosure.

FIG. 4 depicts a block diagram of an example computing system that executes a copresence application according to examples of the present disclosure.

FIG. 5 depicts a set of exemplary actions that can be presented by a first participant to a second participant using the copresence system according to examples of the present disclosure.

FIG. 6 depicts three views that show an example for creation of a silhouette representation using machine-learned models according to examples of the present disclosure.

FIG. 7 depicts an example view of different techniques to reduce imaging issues according to examples of the present disclosure.

FIG. 8 depicts an illustration of the homography technique according to examples of the present disclosure.

FIG. 9 depicts an illustration of the exposure technique according to examples of the present disclosure.

FIG. 10 depicts an illustration of the color settings technique according to examples of the present disclosure.

FIG. 11 depicts a flow chart diagram of an example method to perform according to examples of the present disclosure.

### DETAILED DESCRIPTION

With reference now to the Figures, example implementations will be discussed in further detail.

Participant: As used herein, a participant may refer to any user, group of users, device, and/or group of devices that participate in a live exchange of data (e.g., a copresence interaction, a collaboration, a teleconference, videoconference). More specifically, participant may be used throughout the subject specification to refer to either user(s) or user device(s) utilized by the user(s) within the context of the live exchange of data. For example, a group of participants may refer to a group of users that participate remotely in a videoconference with their own user devices (e.g., smartphones, laptops, wearable devices, teleconferencing devices, broadcasting devices). For another example, a participant may refer to a group of users utilizing a single computing device for participation in a videoconference (e.g., a video conferencing device within a meeting room). For another example, participant may refer to a broadcasting device (e.g., webcam, microphone) unassociated with a particular user that broadcasts data to participants of a teleconference. For yet another example, a participant may refer to a bot or an automated user that participates in a teleconference to provide various services or features for other participants in the teleconference (e.g., recording data from the teleconference, providing virtual assistant services, providing testing services, etc.).

Teleconference: As used herein, a teleconference (e.g., videoconference, audio conference, media conference, Augmented Reality (AR)/Virtual Reality (VR) conference) is any communication or live exchange of data (e.g., audio data, video data, AR/VR data, etc.) between several participants. For example, a teleconference may refer to a videoconference in which multiple participants utilize computing devices to transmit video data and/or audio data to each other in real-time. For another example, a teleconference may refer to an AR/VR conferencing service in which AR/VR data (e.g., pose data, image data, etc.) sufficient to generate a three-dimensional representation of a participant is exchanged amongst participants in real-time. For another example, a teleconference may refer to a conference in which audio signals are exchanged amongst participants over a mobile network. For yet another example, a teleconference may refer to a media conference in which different types or combinations of data are exchanged amongst participants (e.g., audio data, video data, AR/VR data, a combination of audio and video data, etc.).

### Overview

When participants are working together remotely it is difficult to teach hands on. Conversely when participants are working together in the same place it is impossible to occupy the same physical space. In some implementations, the copresence system described herein addresses the choreography of teaching and working together on the same medium (e.g., canvas) in a fingertip-to-fingertip ability, such as teaching the order and steps of calligraphy, drawing, piano keying, or any other hand-to-surface choreography. The copresence system can be portable and able to fit on a table in a home or office environment. The copresence system is designed to be affordable for mass-scale production by using a projector, mirrors and an image capturing device (e.g., mobile device) in a light sealed container (e.g., three-dimensional (3D) printed cardboard container) to support a physical medium (e.g., drawing surface such as glass and vellum).

In some implementations, the copresence system can include components such as an image capturing device (e.g., user's mobile phone), a projector, and a physical presentation medium. The image capturing device can capture inputted information from a first participant, the projector can present information about other participants (e.g., collaborators), and the physical medium can provide a focal point for a shared workspace. For instance, the participants can appear as if they are writing on frosted glass from opposing sides of the shared workspace. Participants at each location see writing with the correct orientation (e.g., the text, drawings or other details can be flipped to not be backwards). Distractions in the background environment can be removed using machine-learning techniques described herein. In addition, privacy concerns and video conferencing fatigue can be addressed by the ease of stepping in and out of the shared interactive experience.

In contrast to conventional video calls, the copresence system promotes quiet, slow thinking and collaboration with a calmer interaction mode. Here, if a participant steps back so that they are outside the field of view of their image capture device, then their respective presence shadow's silhouette would not appear on anyone's physical medium of the shared canvas. Once a participant is ready to rejoin the collaboration at the physical medium, that person can move into the field of view of their image capture device and begin working at the medium. This approach allows ideas to evolve. Additionally, since the participant is represented only by a silhouette (presence shadow), during the period in which they have left the field of view, it is not necessary to capture and share any representation of the participant until they return. In contrast, if the participant were involved in a video conference, for example the video feed of the participant's surroundings would continue to be provided even if the participant had left the field of view, unless the camera were manually switched off. As such, the bandwidth savings described herein are particularly applicable to this scenario.

In some implementations, due to the nature of the physical medium, erasing can be easily performed. For example, an object that a participant adds to their respective physical medium can be integrated into the visualization presented on the shared canvas, and the object can be removed from the visualization when the participant erases the object.

In some implementations, participants at each location can simultaneously brainstorm at their respective physical medium, with the participants viewing the results in real time on the shared canvas. The real-time interaction is accomplished via respective wired or wireless connections for each participant to one another via a network.

In some implementations, a copresence application can present collaboration information that is on the shared canvas on the displays of computing devices (which may be, for example, provide the image capture devices). The copresence application may automatically create bookmarks of the collaborative session, for instance stored in a remote system such as a cloud storage system. By way of example only, the bookmarks could be generated periodically (e.g., every minute, every five minutes, user-defined time interval), every time a participant finishes interacting with the shared canvas, or whenever a participant steps back from the shared canvas. The bookmarks can be easily imported into tools like a presentation application to build on and communicate the ideas more widely.

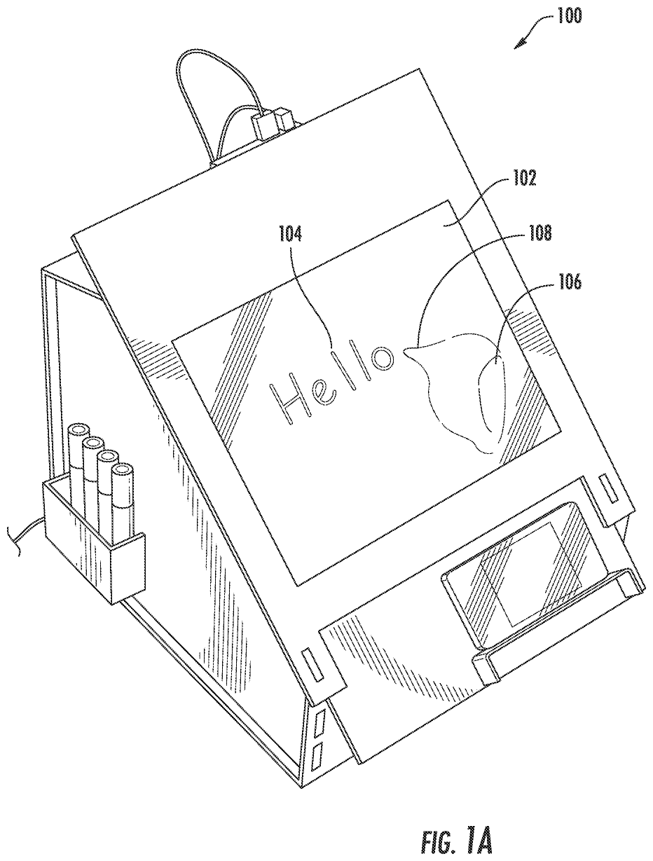

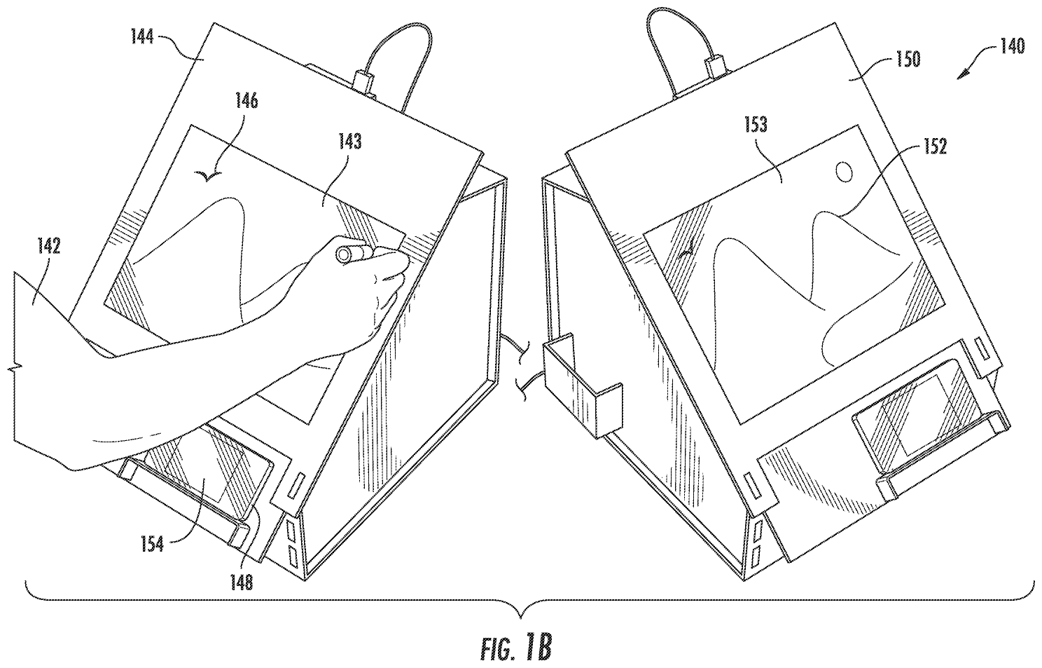

FIG. 1A illustrates an example scenario 100 in which a first participant at a first physical location is watching a second participant write the word “hello” on a copresence system 102 (e.g., copresence device, shared workspace). In this example, the copresence system 102 includes a physical medium 104 at the first participant's location. While not shown, there is a separate physical medium at the second participant's location. The content of the physical media at each location are integrated to provide a shared “canvas” upon which all users can work in real-time.

As shown, a silhouette representation (presence shadow) 106 represents the second participant as presented to the first participant at the first participant's location. In this example, the second participant's representation is shown holding a stylus 108, with which the second participant can write the letters for the word “hello.”

FIG. 1B illustrates another example scenario 140 in which a first participant 142 at a first physical location is drawing a background image 146 on the physical medium 143 of a first copresence system 144, while a second participant at a second physical location is drawings a landscape image 152 on the physical medium 153 of a second copresence system 150. Additionally, the silhouette representation 154 of the second participant is displayed on the first mobile device 148 attached to the first copresence system 144.

Continuing with the example scenario 140, FIG. 1C illustrates the first participant 142 drawing additional elements 160 (e.g., sun, snow covered mountain peaks) on the physical medium 143 of the first copresence system 144, which are presented (e.g., displayed) in real-time on the physical medium 153 of the second copresence system 150. Additionally, the second participant 162 is drawing additional landscape elements 164 (e.g., grass, river) on the physical medium 153 of the second copresence system, which is presented in real-time on the physical medium 143 of the first copresence system 144.

### System Configurations and Architectures

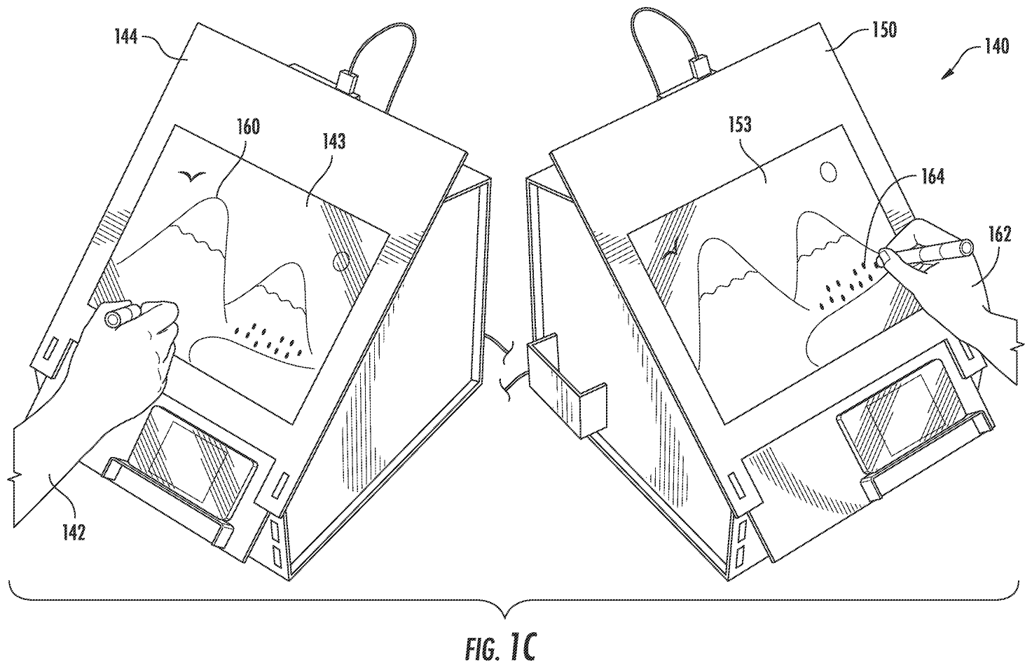

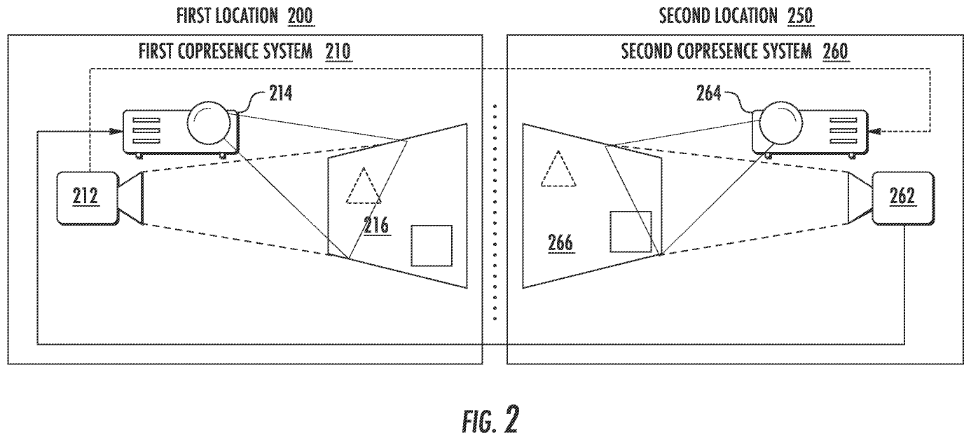

FIG. 2 illustrates an exemplary configuration for a multi-person remote collaboration scenario. As shown, the first user is in a first location 200 and the second user is in a second location 250. The dotted line between the first location 200 and the second location 250 indicates that the users are at different physical locations (e.g., different rooms, homes, offices, schools, conference rooms). The first copresence system 210 at the first location 200 can include an optical device (also referred to herein as image capture device) 212 (e.g., a mobile phone, video conference camera, webcam, etc.), a projector 214, and a physical medium 216. Additionally, speakers (not pictured) may be used to provide spatial acoustics.

Similarly, the second copresence system 260 at the second location 250 can include an image capture device 262, a projector 264, and a physical medium 266. Speakers (not pictured) may be used to provide spatial acoustics that indicate where each other person is positioned in relation to their physical medium. While not shown, the copresence systems 210, 260 may include one or more mirrors to reflect one or more images and/or videos. Additionally, one or more microphones may be employed for audio input. By way of example, the microphones may be integrated into the projector, the image capture device, and/or the physical medium, or may be separately placed in one or more locations in the copresence system 210, 260.

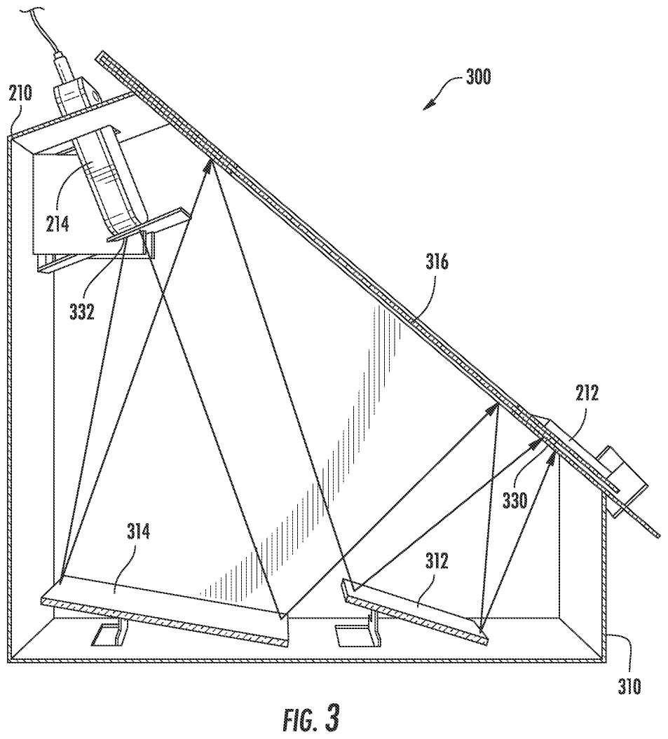

FIG. 3 illustrates a side view 300 showing the first copresence system 210 according to an example of the present disclosure. As shown here, the image capture device 212 and/or the projector 214 can be attached (e.g., positioned, mounted) to a physical box 310 (e.g., container, case, an apparatus that can contain the image capture device 212 and/or the projector). In one example, the projector 214 is attached to a first side of the physical box 310 and the image capture device 212 and the physical medium 316 are attached on a second side of the physical box 310. Additionally, the first copresence system 210 can include an input mirror 312 and a projector mirror 314 attached on a third side of the physical box 310. In this example, the physical box 310 has five sides, but the physical box 310 can have a plurality (e.g., 3, 4, 5, 6, 7, 8) of sides.

Furthermore, in different setups these components may be arranged at separate locations. For instance, the image capture device 212 can be attached on a fourth side of the physical box 310, while the physical medium is still attached on the second side of the physical box 310. The image capture device 212 may also be arranged so that light from the projector 214 does not adversely impact imagery being captured. The projector 214 can be positioned at a determined distance from the physical medium so that the imagery can be projected and reflected off the projector mirror 314 to encompass all or most of the surface area of the physical medium 316. The determined distance can be based on the surface area of the physical medium 316 and/or the angle of the projector mirror 314.

The image capture device 212 has a field of view 330 configured to capture details of the first user using (e.g., writing on, drawing on, touching) the physical medium 316. Imagery captured by the image capture device 212 can be streamed via a wireless network (e.g., Wi-Fi, cellular link). The projector 214 has a field of view 332, and is configured to present information on the physical medium 316 via wired (e.g., an HDMI connection) or wireless network. In this configuration, the collaboration information can be shown on a display device of the image capture device 212 (e.g., mobile device) and on the physical medium 208.

In some implementations, multiple cameras of the image capture device 212 can be utilized to improve the depth perception associated with the silhouette representation. Additionally, the multiple cameras can be positioned at different locations to minimize or eliminate occlusions in front of the physical medium.

While FIG. 3 illustrate an example implementation configuration, FIG. 4 illustrates an example computing system 400 having computing devices at the different participant locations using a copresence application. The application may be a program that is executed locally by the respective client computing devices, or it may be managed remotely such as with a cloud-based app.

FIG. 4 depicts a block diagram of an example computing system 400 that executes a copresence application according to an example of the present disclosure. The system 400 includes a copresence device 402, a server computing system 430, and a participant computing device(s) 450 that are communicatively coupled over a network 480.

The copresence device 402 can include a mobile computing device (e.g., smartphone or tablet), a wearable computing device (e.g., a virtual/augmented reality device), a broadcasting computing device (e.g., a webcam), or any other type of computing device.

The copresence device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage media, such as RAM, ROM, EEPROM, EPROM, flash memory devices, magnetic disks, etc., and combinations thereof. The memory 414 can store data 416 and instructions 418 which are executed by the processor 412 to cause the copresence device 402 to perform operations.

In some implementations, the copresence device 402 can store or include one or more machine-learned models 420. For example, the machine-learned models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 420 can be received from the server computing system 430 over network 480, stored in the user computing device memory 414, and then used or otherwise implemented by the one or more processors 412.

The copresence device 402 can also include one or more user input components 422 that receives user input. For example, the user input component 422 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the copresence device 402 can include, or can be communicatively coupled with, input device(s) 424. In some instances, the copresence device 402 can be a copresence system (e.g., first copresence system 144, second copresence system 150). In one embodiment, the copresence device 402 can be the first copresence system 144 without an image capture device (e.g., first mobile device 148).

Alternatively, the copresence device 402 can just be a mobile device (first mobile device 148, image capture device 212) that provides the image capturing functionality. For example, the input device(s) 424 may include a camera device configured to capture two-dimensional video data of a user of the copresence device 402 (e.g., for broadcast). In some implementations, the input device(s) 424 may include several camera devices communicatively coupled to the copresence device 402 that are configured to capture image data from different poses for generation of three-dimensional representations (e.g., a representation of a user of the copresence device 402). In some implementations, the input device(s) 424 may include audio capture devices, such as microphones. In some implementations, the input device(s) 424 may include sensor devices configured to capture sensor data indicative of movements of a user of the copresence device 402 (e.g., accelerometer(s), gyroscope(s), infrared sensor(s), head tracking sensor(s) such as magnetic capture system(s), sensor(s) configured to track eye movements of the user).

In some implementations, the copresence device 402 can include, or be communicatively coupled to, output device(s) 426. Output device(s) 426 can be, or otherwise include, a device configured to output audio data, image data, video data. For example, the output device(s) 426 may include a two-dimensional display device (e.g., a television, projector 214, smartphone display device, physical medium 316) anda corresponding audio output device (e.g., speakers, headphones). For another example, the output device(s) 426 may include display devices for an augmented reality device or virtual reality device.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which the server computing system 430 includes plural server computing devices, such server computing devices can operate according to sequential computing architectures, parallel computing architectures, or some combination thereof.

The server computing system 430 can store or otherwise include one or more machine-learned models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the server computing device 430 can receive data of various types from the copresence device 402 (e.g., via the network 480). For example, in some implementations, the copresence device 402 can capture video data, audio data, multimedia data (e.g., video data and audio data), sensor data, etc. and transmit the data to the server computing system 430. The server computing system 430 may receive the data (e.g., via the network 480).

In some implementations, the server computing system 430 may receive data from the user computing device 430 according to various encryption scheme(s) (e.g., codec(s), lossy compression scheme(s), lossless compression scheme(s)). For example, the copresence device 402 may encode video data with a video codec, and then transmit the encoded video data to the server computing system 430. The server computing system 430 may decode the encoded video data with the video codec. In some implementations, the copresence device 402 may dynamically select between several different codecs with varying degrees of loss based on conditions of the network 480, the copresence device 402, and/or the server computing device 430. For example, the copresence device 402 may dynamically switch from video data transmission according to a lossy encoding scheme to video data transmission according to a lossless encoding scheme based on a signal strength between the copresence device 402 and the server computing system 430.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the copresence device 402, the server computing system 430, and/or the participant computing device(s) 450 can include a copresence application 442. The copresence application 442 may be configured to facilitate teleconference services for multiple participants. For example, the copresence application 442 may receive and broadcast data (e.g., video data, audio data, etc.) between the copresence device 402 and participant computing device(s) 450. A copresence application 442 can be any type of application or service that receives and broadcasts data from multiple participants. For example, in some implementations, the copresence application 442 may be a videoconferencing service that receives data (e.g., audio data, video data, both audio and video data, etc.) from some participants and broadcasts the data to other participants.

As an example, the copresence application 442 can provide a videoconference service to multiple participants. One of the participants can transmit audio and video data to the copresence application 442 using a copresence device 402. A different participant can transmit audio data to the copresence application 442 with another copresence device. The copresence application 442 can receive the data from the participants and broadcast the data to each user device of the multiple participants.

As another example, the copresence application 442 may implement an augmented reality (AR) or virtual reality (VR) conferencing service for multiple participants. One of the participants can transmit AR/VR data sufficient to generate a three-dimensional representation of the participant to the copresence application 442 via a device (e.g., video data, audio data, sensor data indicative of a pose and/or movement of a participant). The copresence application 442 can transmit the AR/VR data to devices of the other participants. In such fashion, the copresence application 442 can facilitate any type or manner of teleconferencing services to multiple participants.

It should be noted that the copresence application 442 may facilitate the flow of data between participants (e.g., copresence device 402, participant computing device(s) 450) in any manner that is sufficient to implement the copresence service (e.g., video conferencing service). In some implementations, the copresence application 442 may be configured to receive data from participants, decode the data, encode the data, and broadcast the data to other participants. For example, the copresence application 442 may receive encoded video data from the copresence device 402. The copresence application 442 can decode the video data according to a video codec utilized by the copresence device 402. The copresence application 442 can encode the video data with a video codec and broadcast the data to participant computing devices.

Additionally, or alternatively, in some implementations, the copresence application 442 can facilitate peer-to-peer teleconferencing services between participants. For example, in some implementations, the copresence application 442 may dynamically switch between provision of server-side teleconference services and facilitation of peer-to-peer teleconference services based on various factors (e.g., network load, processing load, requested quality).

The copresence device 402 can receive video data broadcast from the copresence application 442 of server computing system 430 as part of a videoconferencing service. In some implementations, the copresence device 402 can upscale or downscale the video data based on a role associated with the video data. For example, the video data may be associated with a participant with an active speaker role. The copresence device 402 can upscale the video data associated with the participant in the active speaker role for display in a high-resolution display region (e.g., a region of the output device(s) 426). For another example, the video data may be associated with a participant with a non-speaker role. The copresence device 402 can downscale the video data associated with the participant in the non-speaker role using a downscaling algorithm (e.g., lanczos filtering, Spline filtering, bilinear interpolation, bicubic interpolation, etc.) for display in a low-resolution display region. In some implementations, the roles of participants associated with video data can be signaled to computing devices (e.g., copresence device 402, participant computing device(s) 450, etc.) by the copresence application 442 of the server computing system 430.

In one example, each participant's computing device 450 may connect with the computing devices of each of the other participants via the network. Here, the copresence application 440 may be run locally on each computing device. In another example, the server computing device may host the copresence application 442, and each computing device may communicate with the other computing devices via the server. In a broadcast mode embodiment, the participant computing device 450 can devices that are on view-only mode and may not have an image capture device (e.g., image capture device 212). For example, a first set of users (e.g., instructors) can have a copresence system 402 and a second set of users (e.g., thousands of users) can have a participant computing device 450. The first set of users can provide input to the physical medium (e.g., physical medium 316) to be shared with all the participants, and the second set of users can view the collaboration information without having the functionality to provide input.

The server computing system 430 and the copresence device 402 can communicate with the participant computing device(s) 450 via the network 480. The participant computing device(s) 450 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), or any other type of computing device.

The participant computing device(s) 450 includes one or more processors 452 and a memory 454. The one or more processors 412 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media, such as RAM, ROM, EEPROM, EPROM, flash memory devices, magnetic disks, etc., and combinations thereof. The memory 454 can store data 456 and instructions 458 which are executed by the processor 452 to cause the participant computing device 450 to perform operations.

In some implementations, the input to the machine-learned model(s) 420, 440 of the present disclosure can be image data (e.g., one or more images or videos). The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some cases, the machine-learned model(s) can be configured to perform a task that includes encoding input data for reliable and/or efficient transmission or storage (and/or corresponding decoding). For example, the task may be an image compression task. The input may include image data and the output may comprise compressed image data. In another example, the input includes visual data, the output comprises compressed visual data, and the task is a visual data compression task. In another example, the task may comprise generating an embedding for input data (e.g., image data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

### Silhouette Representations/Presence Shadows

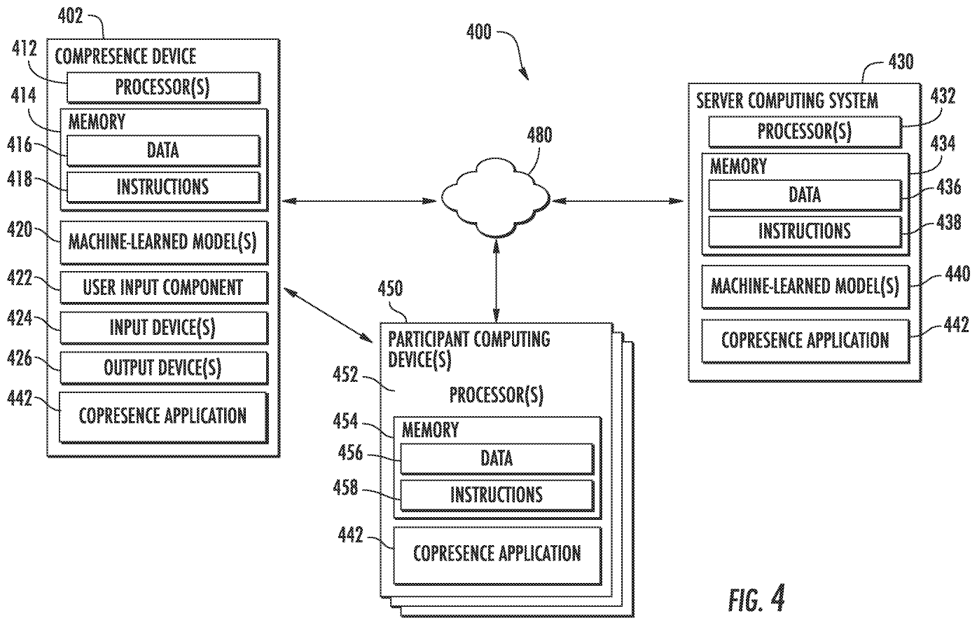

FIG. 5 depicts a set of exemplary actions (e.g., presence 510, gesture 520, point 530, follow 540, motion 550) that can be presented by a first participant to a second participant using the copresence system according to an example of the present disclosure. One beneficial aspect of the technology is that the content shown on the shared workspace is presented with high fidelity in high resolution (e.g., more than 250 pixels per inch), while the users' representations are intentionally created to have a lower resolution that appears as silhouettes (e.g., less than 250 pixels per inch). By using lower resolution for the silhouettes, the system reduces network bandwidth and the amount of data transmitted between the different devices at different locations.

The silhouettes can convey meaningful information about how the users are interacting in the collaborative experience. As illustrated in the exemplary views of FIG. 5, the content can be clearly discernible even though the user's hand get within a certain proximity to their medium has their shadow presence also visible to other participants. Other participants can view the silhouettes on their display in real-time, which is an example of a copresence environment. The copresence environment enables participants to view the location where another participant with different actions (e.g., gesture 520, point 530, follow 540) allowing you to collaborate in a more tactile and intuitive way. The copresence system can present the actions in a way that does not detract from the ink and feels gentle enough to maintain the collaboration flow.

To create the visuals for the silhouettes, the image capture device 212 includes a depth camera. This can be a depth camera on a mobile phone, a stand-alone camera unit that has two or more imaging units, or separate cameras that in combination can provide the depth information. In addition, for use in generating the presence shadows, the information from the depth camera can be used to detect (and correct for) occlusion of a portion of the physical medium. The image capture device 212 can observe (e.g., capture, receive) the image (e.g., the user that is being observed through the physical medium 316) that is reflected by the input mirror 312.

In other scenarios, in addition to information from the image capture device 212, other information regarding depth may also be provided by a radar sensor, a lidar sensor, an acoustical sensor (e.g., sonar) and/or any combination thereof. By way of example, such information may be used to provide additional details about user hand gestures either at or away from the shared canvas (e.g., the positioning and/or spacing of the fingers, how a pencil or brush is being held, etc.), used to overcome occlusion of the image capture device, or otherwise enrich the information used to create a participant's shadow presence. Thus, using one of these other types of sensors can serve in detecting and helping to visualize a more abstract approximation of presence. For instance, location and pose information about the person can be used to generate a visualization in which their shadow changes from a humanoid shape to a dot or blob as the person moves away (and the reverse as the person moves closer), which will still move coordinated with the person at the other end. This type of visualization would retain a sense of copresence but without the fidelity of a full body shadow.

In some implementations, the visuals for silhouettes can also be achieved by a very simple inexpensive analog diffuser (e.g., a frosted acetate). For example, the physical medium can include a frosted acetate. Given that the silhouettes are generated based on the proximity to the physical medium, it enables participants to naturally take a step back from the physical medium to disappear from the projected image. For example, a participant may want to step back and not show their silhouette when talking privately to another user in their physical space.

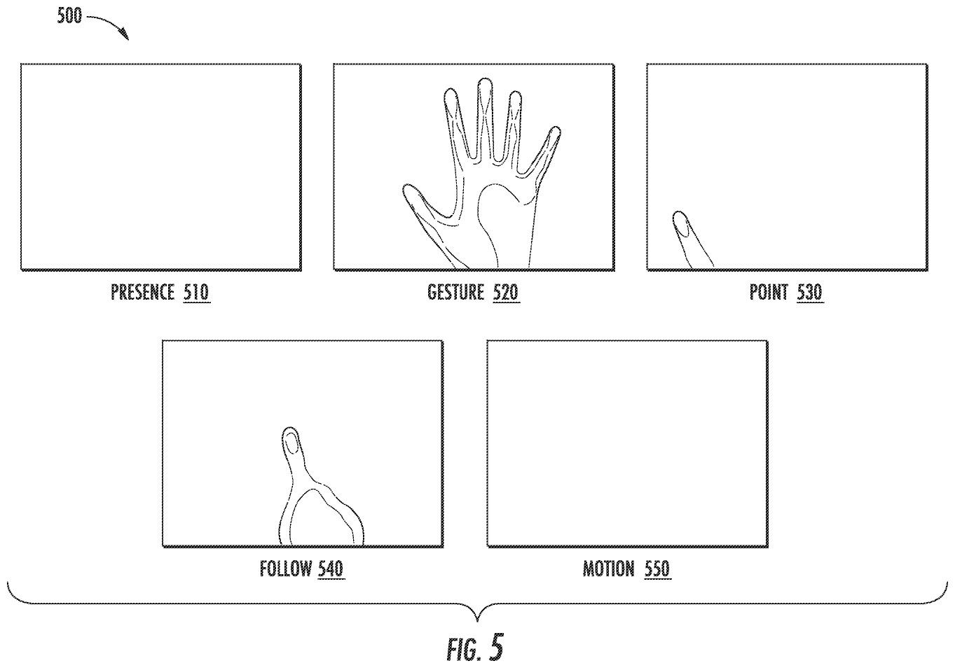

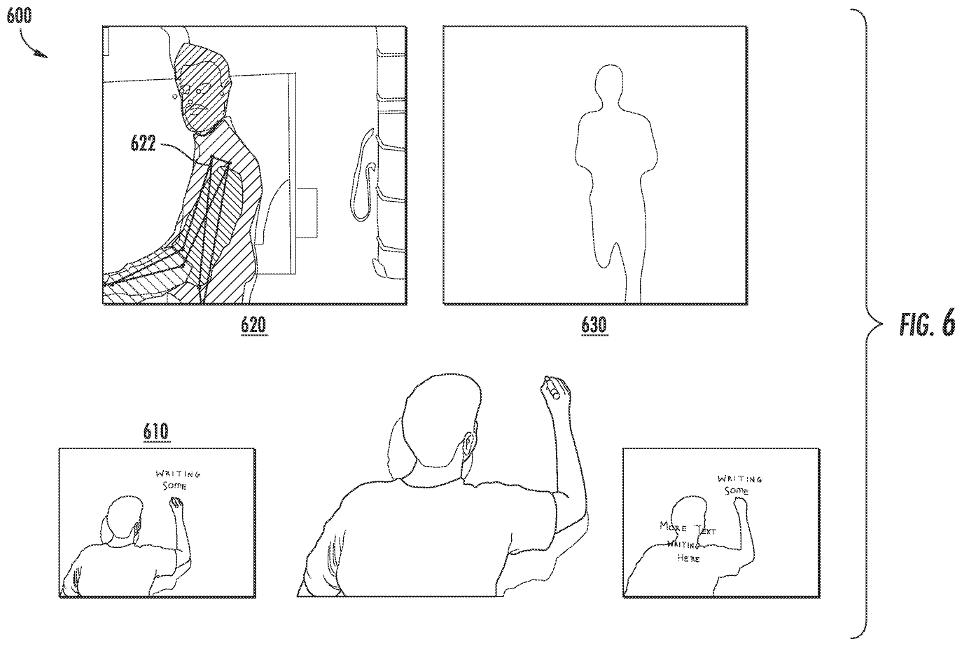

FIG. 6 illustrates three views that show an example for creation of a silhouette representation using machine-learned models according to an example of the present disclosure. For example, the machine-learned models can be the machine-learned model(s) 420, 440 that are described in FIG. 4. First, as seen in view 610, a raw image of the person is captured. Then, as seen in view 620, skeleton coordinates 622 of various points along the person's body are determined (e.g., joints, head features, hand features, arm features, leg features, foot features), which is used for posing estimation. By way of example, the skeleton coordinates may be determined using a machine learning image processing model described in FIG. 4. That is, pixels of the raw image may be provided as input to a machine-learned model trained to process the pixels of the raw image and to identify and provide as output skeleton coordinates 622. Suitable machine-learned models will be apparent to the skilled person, but include, by way of example, machine-learned models including one or more convolutional layers, and/or self-attention layers (e.g., image transformers). Such machine-learned models may be trained in any appropriate manner as will be known to the skilled person. From the information obtained at 620, the copresence device 402 can create a silhouette representation on the shared canvas at another person's location, as illustrated in view 630. Although the silhouette in view 630 is of a human body, in other implementations, the silhouette representation can be a hand action as described in FIG. 5.

In some implementations, in the case where a copresence application 442 is hosted remotely from the user devices, it may be beneficial to transmit only skeleton coordinates from the participant's respective locations to the service so that the pose estimation is done centrally, in contrast to sending estimated pose information to the service. This can result in reduced transmission overhead and avoid the need for dedicated computing resources at each participant's location, which may be particularly beneficial when there are many participants (e.g., 10, 20 or more participants).

In some implementations, using machine-learned models to segment the participant (e.g., hand of the participant) from the canvas enables capture of both a detailed hi-resolution live feed of the content without the human obstruction and application of filters (e.g., effects) to the captured image of the participant to produce a semi-transparent appearance.

In some implementations, the copresence device 402 can generate presence shadow using depth map information. Depth map information can be extracted from the original image. For instance, the copresence device 402 can set the background details to one color (e.g., white), and the copresence device 402 can set the foreground details at or near the surface of the physical medium (e.g., a screen) to a visually contrasting color (e.g., gray, black). Then, the copresence device 402 can blur features or make them otherwise more diffuse according to their depth. For example, while the finger of a participant is close and presented sharply, the hand of the participant may be blurred by the copresence device 402. Using the blurring and silhouette representation, the copresence application 442 can achieve a user experience that includes a high body language fidelity so that participants can accurately perceive the body language of other participants. This is accomplished at low latency (e.g., updates can be made on a frame-by-frame basis from the original video) so that real-time collaboration is enhanced.

In some implementations, a silhouette representation of a participant can change in relation to the distance of the participant (e.g., finger of a participant, hand of a participant) in relation to the physical medium. For instance, as the participant starts their interaction, a finger can move towards their physical medium. Once the finger is within a threshold distance to the physical medium and is within the field of view of the image capture device at their location, a silhouette representation for the finger of the participant appears on the shared canvas for all participants. As the participant presses their finger on the physical medium, the sharpness of the silhouette representation (e.g., shadow of the finger) increases.

While it may be readily apparent which silhouette representation is associated with a given participant, e.g., due to different sizes, types, etc., there are different ways the system can augment the silhouette representation for each participant. By way of example, a different color, shading, chroma, glossiness and/or texture may be assigned to or selected by each participant (e.g., according to a user profile or as part of a user interface of the copresence application 442). Participant names, tags, insignia or other textual or graphical indicators can be placed on or adjacent to different presence shadows. In addition, when a person is speaking, their presence shadow could be highlighted, outlined, pulsate, or otherwise changed in appearance. Any or all these differentiators may be employed. In one example, at least one differentiator may be employed when a participant joins the collaborative application 442, and then having the differentiator change after a selected amount of time (e.g., 5-10 seconds) or once another person joins.

### Reducing Imaging Issues

The copresence device 402 enables the participants at each location to view context on their physical medium that includes the other participants, the textual and/or graphical information that all the participants are collaborating on. The copresence device 402 enables information presented on the physical medium to be of similar scale (e.g., with a 1:1 scale), so that the participants have a similar view. The participants at each location can also view the silhouette representations of the other participants (but not their own).

Techniques described herein can reduce imaging issues such as visual echo and feedback, which can adversely impact streaming video between copresence devices 402. Thus, calibration can be performed by the copresence application 422 to reduce imaging issues.

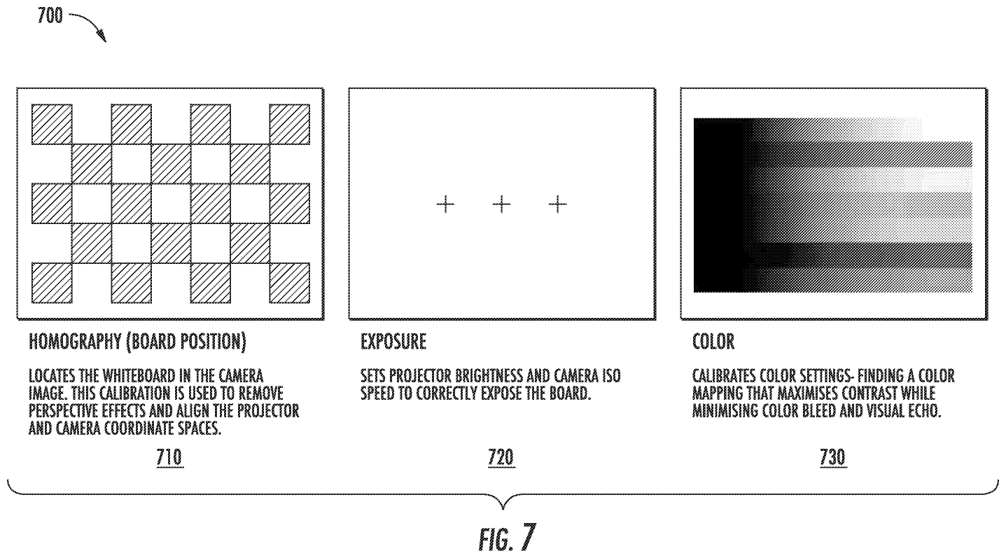

FIG. 7 illustrates an example view of 700 of different techniques 710, 720, 730 to reduce imaging issues according to an example of the present disclosure. For instance, the copresence device 402, using an homography technique 710, can locate the canvas in the image obtained by the image capture device 212. The homography technique enables calibration to remove perspective effects and align the projector and image capturing device coordinate spaces. Additionally, the copresence device 402, using an exposure technique 720, can adjust (e.g., modify) the projector brightness and camera's sensitivity to light (e.g., ISO number) to correctly expose the canvas. Moreover, the copresence device 402, using a color settings technique 730, can calibrate color settings by finding a color mapping that maximizes contrast while minimizing color bleed and visual echo.

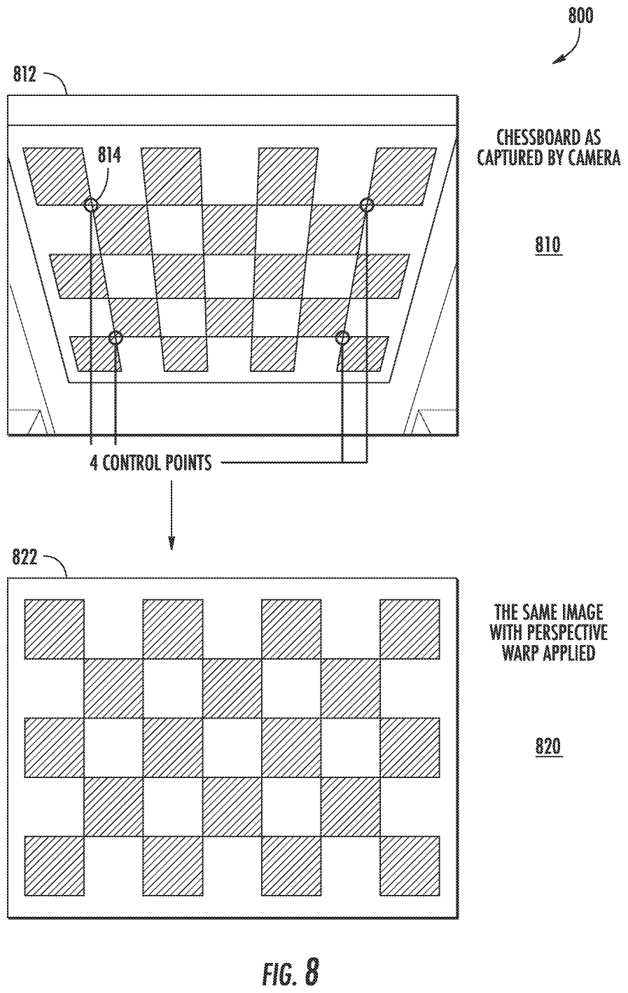

FIG. 8 depicts an illustration 800 of the homography technique according to examples described in the present disclosure. For example, the projector can display a chessboard 812 on the physical medium. As illustrated in view 810, the image capturing device can capture the chessboard 812 and the copresence application 442 can determine a plurality (e.g., four) of control points 814. The control points 814 can be determined by selecting the corners of the chessboard as illustrated in view 810. As illustrated in view 820, the copresence application 442 can modify the chessboard to generate an updated chessboard 822 by applying a perspective warp based on the determined control points.

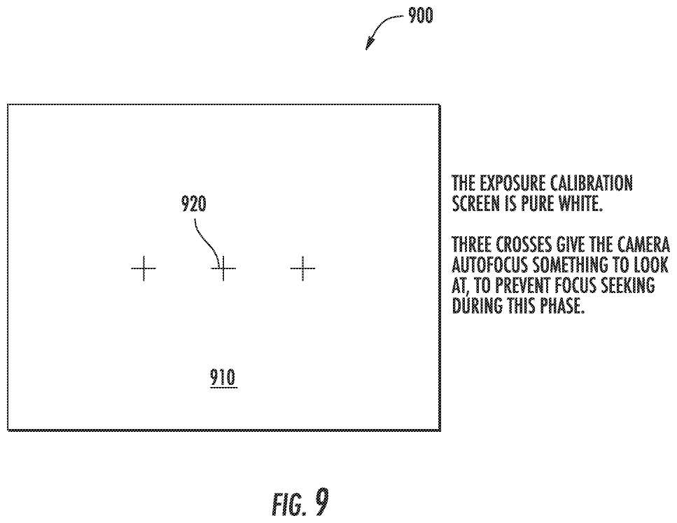

FIG. 9 depicts an illustration 900 of the exposure technique according to an example of the present disclosure. As illustrated in illustration 900, the exposure calibration screen 910 can be pure white. Three crosses 920 may be projected onto the canvas by the projector. An autofocus of the image capturing device can utilize the three crosses 920 to focus the image. In some instances, the exposure technique is performed at initiation to reduce the focus seeking during the collaboration

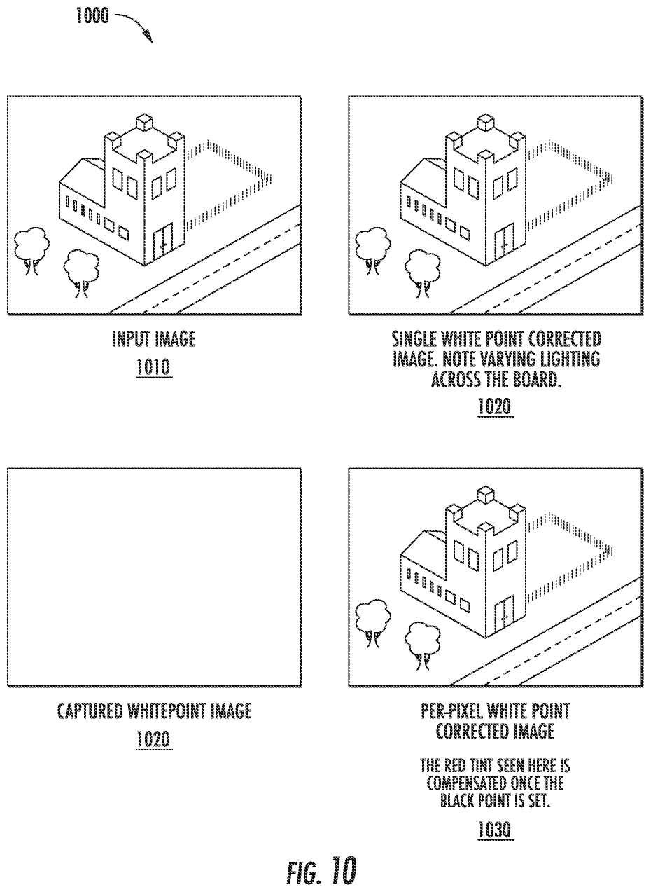

FIG. 10 depicts an illustration 1000 of the color settings technique according to an example of the present disclosure. As illustrated, the input image 1010 is modified by the copresence application 442 to a corrected image 1020 with a reduction of varying lighting across the image. The corrected image 1020 can be a single white point corrected image with varying lighting across the board. The copresence application can utilize a captured white-point image 1020 to generate a per-pixel white-point corrected image 1030. For example, a tint degree can be adjusted for each of the pixels in the per-pixel white-point corrected image 1030 using machine-learned models 420.

### Copresence Enhancements

As noted above, when using a copresence app to collaborate with remote participants, the system may create bookmarks-snapshots of the shared canvas—at different points in time. The bookmarks may be stored in a database (e.g., memory 434) that is accessible to the participants, or locally in memory (e.g., memory 414, memory 454) of a given participant's computing device. The bookmarks could be viewed by participants that join later to see the evolution of the collaboration without having to ask the other participants what happened previously. In one example, any participant would be able to manually create a bookmark. For instance, this could be done with a hand gesture or certain body pose, pressing a key (e.g., the spacebar) on the participant's computer, using a separate tool such as a programmable button that is connected to the computer (or physical medium) via a Bluetooth connector, speaking a command, etc.

In another scenario, information from the collaboration may be automatically captured and imported into a task list or calendar program. Here, for example, the system may identify one or more action items for at least one participant, and automatically add such action item(s) to a corresponding app, such as by synchronizing the action item(s) with the corresponding app.

In a further scenario, a transcript of a copresence session may be generated using a speech-to-text feature. The transcript may be time stamped along with the timing for when information was added to, removed from, or modified on the shared canvas. In this way, it could be easy to determine the context for why a particular decision was made.

Depending on the configuration of the copresence application 442, in yet another scenario the system could allow participants to create the user interface they need, when they need it, e.g., by drawing it on the shared canvas. For example, like a form of programming, this approach would allow users to customize their experience, while reducing computational overhead associated with maintaining elements of a user interface that are not functional-instead, they are created when needed.

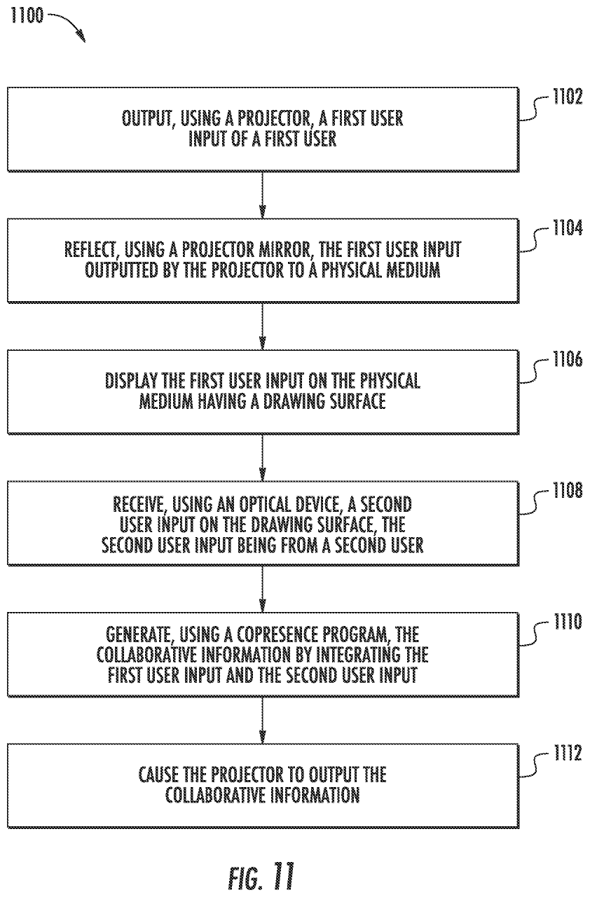

FIG. 11 depicts a flow chart diagram of an example method to perform according to an example of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

At 1102, a computing system can output, using a projector, a first user input of a first user. For example, the first user can use an input tool to draw on a physical medium of a first copresence device.

At 1104, the computing system can reflect, using a projector mirror, the first user input outputted by the projector to a physical medium. For example, the projector mirror 314 in FIG. 3 can reflect the first user input outputted by the projector 214 to the physical medium 316 in FIG. 3.

At 1106, the computing system can display the first user input on the physical medium having a drawing surface. For example, the first user input can be displayed on the physical medium 316 in FIG. 3. In some instances, the drawing surface of the physical medium can include vellum.

At 1108, the computing system can receive, using an optical device, a second user input on the drawing surface. The second user input being from a second user. For example, the second user can use an input tool to draw on a physical medium of a second copresence device.

At 1110, the computing system can generate, using a copresence program, the collaborative information by integrating the first user input and the second user input. The content of the physical media at each location are integrated to provide a shared canvas upon which all users can work in real-time. Additionally, an object that a participant adds to their respective physical medium can be integrated into the visualization presented on the shared canvas, and the object can be removed from the visualization when the participant erases the object.

At 1108, the computing system can cause the projector to output the collaborative information. For example, the projector 214 in FIGS. 2 and 3 can project the collaborative information to the projector mirror 314. The collaborative information is then reflected from the projector mirror 314 to the the physical medium 316.

The technology discussed herein refers to servers, databases, software applications, and other computer-based systems, as well as actions taken, and information sent to and from such systems. The inherent flexibility of computer-based systems allows for a great variety of configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific examples thereof, each example is provided by way of explanation, not limitation of the disclosure. Those skilled in the art, upon attaining an understanding of the foregoing, can readily produce alterations to, variations of, and equivalents to such examples. Accordingly, the subject disclosure does not preclude inclusion of such modifications, variations and/or additions to the present subject matter as would be readily apparent to one of ordinary skill in the art. For instance, features illustrated or described as part of one example can be used with another example to yield a still further example. Thus, it is intended that the present disclosure covers such alterations, variations, and equivalents.

FIG. 9 illustrates a method 900 in accordance with aspects of the technology. At block 902, the method includes accessing, via a first computing device associated with a first user at a first physical location, a copresence program configured to support multiple participants. The first physical location includes a first physical medium configured to display information of the copresence program. At block 904, the method includes receiving, by one or more processors associated with the first physical location, depth map information of a second participant at a second physical location. The depth map information is derived from a raw image associated with the second participant captured at the second physical location. Then at block 906, the method includes generating, by the one or more processors associated with the first physical location, a presence shadow corresponding to the second participant. The presence shadow is used to reproject aspects of the second participant according to the depth map information where the aspects are blurred according to a proximity of each aspect to a second physical medium at the second physical location. And in block 908, the method includes displaying using the copresence program, on the first physical medium, the presence shadow corresponding to the second participant.

Although the technology herein has been described with reference to examples, it is to be understood that these examples are merely illustrative of the principles and applications of the present technology. It is therefore to be understood that numerous modifications may be made to the illustrative examples and that other arrangements may be devised without departing from the scope of the present technology as defined by the appended claims.

As discussed herein, tactile copresence among two or more remote participants can be employed in various real-time interactive applications. Video Conferencing apps, brainstorming meetings, personal tutorial or training sessions, games and other activities can be implemented with simple physical setups. By only sending body profile information instead of transmitting full-motion video, significant reductions in bandwidth can be achieved. By using skeleton coordinates or other depth-map information received by the other computing devices to form a 3D reprojection of the participant as a presence shadow, full image details of the participant and other items in the background environment are not shown. In addition to reducing bandwidth, this also helps minimize unnecessary details, which can enhance user comfort with being on-screen.

1. A system comprising:
a projector configured to output a first user input of a first user;
a projector mirror configured to reflect the first user input outputted by the projector to a physical medium;
the physical medium, the physical medium having a drawing surface and being configured to display the first user input; and
a first computing device having one or more processors, the one or more processors causing the first computing system to perform operations, the operations comprising:
receiving, using an optical device of the first computing device, a second user input on the drawing surface, the second user input being from a second user;
generating, using a copresence program, collaborative information by integrating the first user input and the second user input; and
causing the projector to output the collaborative information.

2. The system of claim 1, the system further comprising:
an input mirror configured to reflect the second user input from the physical medium to the optical device of the first computing device.

3. The system of claim 1, the operations further comprising:
receiving, using the optical device of the first computing device, a raw image associated with an input tool of the second user; and
generating a silhouette representation corresponding to the input tool of the second user, the silhouette representation reprojecting aspects of the input tool according to a proximity of the input tool to the physical medium.

4. The system of claim 3, wherein a first section of the silhouette representation is generated to have a first amount of blurring, and wherein the first amount of blurring is based on the proximity of the input tool to the physical medium.

5. The system of claim 3, wherein the silhouette representation is configured to illustrate an action of the input tool of the second user, the action being either a point action or a follow action.

6. The system of claim 3, wherein the collaborative information is displayed at a first resolution while the silhouette representation is displayed at a second resolution lower than the first resolution.

7. The system of claim 3, wherein the silhouette representation is generated based on a set of skeleton coordinates derived from the raw image.

8. The system of claim 1, wherein the system further comprising:
a three-dimensionally printed container.

9. The system of claim 8, wherein the projector is attached to a first side of the container, wherein the projector mirror and the input mirror are attached to a second side of the container, and the physical medium and the first computing device are attached to a third side of the container.

10. The system of claim 1, wherein the physical medium comprises vellum.

11. The system of claim 1, the operations further comprising:
generating a bookmark associated with a time stamp, the bookmark including the collaborative information at the time stamp.

12. The system of claim 1, the operations further comprising:
improving, using an homography technique, an image quality associated with the collaboration information, the homography technique having a calibration image with a plurality of control points being outputted by the projector to determine an amount of perspective warp.

13. A computer-implemented method, the method comprising:
outputting, using a projector, a first user input of a first user;
causing a reflection, using a projector mirror, the first user input outputted by the projector to a physical medium;
displaying the first user input on the physical medium, the physical medium having a drawing surface;
receiving, using an optical device of a first computing device, a second user input on the drawing surface, the second user input being from a second user;
generating collaborative information by integrating the first user input and the second user input; and
causing the projector to output the collaborative information.

14. The computer-implemented method of claim 13, the method further comprising:
reflecting, using an input mirror, the second user input from the physical medium to the optical device of the first computing device.

15. The computer-implemented method of claim 13, the method further comprising:
receiving, using the optical device of the first computing device, a raw image associated with an input device of the second user; and
generating a silhouette representation corresponding to the input device of the second user, the silhouette representation reprojecting aspects of the input device according to a proximity of the input device to the physical medium.

16. The computer-implemented method of claim 15, wherein a first section of the silhouette representation is generated to have a first amount of blurring, and wherein the first amount of blurring is based on the proximity of the input device to the physical medium.

17. The computer-implemented method of claim 15, wherein the silhouette representation is configured to illustrate an action of the input device of the second user, the action being either a point action or a follow action.

18. The computer-implemented method of claim 13, the method further comprising:
attaching the projector to a first side of a container;
attaching the projector mirror and an input mirror to a second side of the container; and
attaching the physical medium and the first computing device to a third side of the container.

19. The computer-implemented method of claim 13, the method further comprising:
improving, using an homography technique, an image quality associated with the collaboration information, the homography technique having a calibration image with a plurality of control points being outputted by the projector to determine an amount of perspective warp.

20. One or more non-transitory computer-readable media that store instructions that, when executed by one or more processors of a computing system, cause the computing system to perform operations comprising:
outputting, using a projector, a first user input of a first user;
causing a reflection, using a projector mirror, the first user input outputted by the projector to a physical medium;
displaying the first user input on the physical medium, the physical medium having a drawing surface;
receiving, using an optical device of a first computing device, a second user input on the drawing surface, the second user input being from a second user;
generating collaborative information by integrating the first user input and the second user input; and
causing the projector to output the collaborative information.
